(19) United States
(12) Patent Application Publication
(10) Pub. No.: US 2006/0038461 A1
(43) Pub. Date: Feb. 23, 2006

(54) Optimized air core armature

(76) Inventor: Christopher W. Gabrys, Reno, NV (US)

Correspondence Address: J. Michael Neary;Neary Law Office, 53939 Pine Grove Road, La Pine, OR, 97739, US

(21) Appl. No.: 11/207,375

(22) Filed: Aug. 18, 2005

Related U.S. Application Data
(60) Provisional application No. 60/602,948, filed on Aug. 19, 2004.

(51) Int. Cl. H02K 21/12; H02K 1/22; H02K 16/00

(52) U.S. Cl. 310/266; 310/156.26; 310/156.37; 310/268

(57) ABSTRACT

An air core motor-generator has a rotor that is journalled to rotate about an axis of rotation, and a stator that is stationary and magnetically applies torque to the rotor. The rotor has magnetic poles that drive magnetic flux across an armature airgap, and the stator has an air core armature located in the armature airgap. Windings on the armature cause AC voltage to be induced in the windings as the rotor rotates. The windings include active length portions that are located in the armature airgap to receive the magnetic flux and induce the AC voltage, and end turn portions that traverse circumferentially and connect together the active length portions. The magnetic poles have a circumferential pole pitch, Y, and the active length portions of the windings having an active length circumferential width of a single phase, X, such that 0.5 Y<X<Y.

This invention pertains to brushless motor-generators and more particularly to air core motor-generators that employ a new armature with a special windings configuration that increases the efficiency and power capability while also facilitating easy manufacturing.

### BACKGROUND OF THE INVENTION

Air core motor-generators have the potential to provide higher efficiency and performance than conventional type electrical machines. They achieve these advantages by eliminating slot wound armature windings wherein the windings are wound in slots in a steel stator, and instead locate the windings within the magnetic airgap. Air core motor-generators can utilize single rotating or double rotating construction. Single rotating construction utilizes a loss mitigating ferromagnetic stator on one side of the airgap. Double rotating air core motor-generators eliminate the need to pass a circumferentially varying flux through a ferromagnetic stator by bounding both sides of the magnetic airgap by rotating surfaces of the rotor.

Various different methods for constructing air core armatures have been utilized along with different winding pattern configurations. Unfortunately, existing air core motor-generators do not achieve their maximum possible potential for efficiency and performance. A new type of air core armature for motor-generators is therefore needed.

### SUMMARY OF THE INVENTION

The invention provides a brushless air core motor-generator having an armature with special windings configuration that increases efficiency and power capability with easy manufacturing. The motor-generator is comprised of a rotor that is journalled to rotate about an axis of rotation and a stator that is stationary and magnetically applies torque to the rotor. The rotor comprises magnetic poles that drive magnetic flux across an armature airgap and the stator comprises an air core armature located in the armature airgap and comprising windings such that AC voltage is induced in the windings as the rotor rotates. The windings comprise active length portions that are located in the armature airgap, receive the magnetic flux and induce the AC voltage, and end turn portions that traverse circumferentially and connect together the active length portions. The magnetic poles have a circumferential pole pitch, Y, and the active length portions of the windings have an active length circumferential width of a single phase, X, such that 0.5 Y<X<Y. More preferably, 0.55 Y<X<0.90 Y. Unlike trapezoidal windings wherein X=Y/3 or full phase layer windings wherein X=Y, the invention provides a unique and unexpected reduction of the armature resistive losses and an increase of the efficiency and power capability of the motor-generator. The result is particularly surprising because the armature has a lower winding density, yet it achieves higher performance. This result is contrary to the design principles that are well known in the art of air core armatures.

The functioning of the motor-generator of this invention can be understood by studying the circumferential field flux distribution and its interaction with the windings for generation of the back emf and in the resistive loss contributions of different wires in an air core armature. As will be shown, the field flux density at the circumferential ends of the magnetic poles of the rotor suffers from fringing and leakage. Because of the much larger magnetic airgap used in air core motors and generators, the leakage portion between adjacent poles is much larger. As a result, the circumferential flux density distribution in the armature airgap suffers from significant circumferential areas near the interfaces between adjacent poles where the flux density is greatly reduced. It has been found that reducing the number of windings and particularly, the circumferential width of the active length portion of a phase to be less than the pole pitch but greater that one half of the pole pitch, the resistive losses can be reduced while the back emf produced is not as appreciably affected. The end windings of a phase approaching wherein the active length width is equal to the pole pitch do not significantly participate in the voltage generation due to the circumferential armature airgap flux density distribution, yet they significantly add to the armature resistance. Eliminating these end windings by reducing the active length width as specified actually increases the motor-generator performance despite the fact that the armature has a lower windings density.

In another embodiment, the circumferential width of a section of the air core armature comprising one set of active lengths of each phase is substantially greater than the circumferential pole pitch, and the circumferential width of the active length portion of a single phase is less than the circumferential pole pitch.

In an additional embodiment, the air core armature has two sides that are perpendicular to the magnetic flux and has a first winding layer that is closest to one side and a second winding layer that is closest to the second side. The active lengths of one phase winding lie only in the first winding layer, active lengths of a second phase winding lie only in the second winding layer and active lengths of a third phase winding lie in more than one winding layer.

The air core armature can be used with both radial and axial gap motor-generators. When the armature airgap is axial, the pole pitch and the active length circumferential width are herein defined by their values at the location of the inner diameter of the magnetic poles.

In yet a further embodiment, the armature can utilize the teachings of having the active length circumferential width lying in the specified range but can also choose a specified width to increase the armature winding density and further increase performance. In this construction, the active length circumferential width is approximately equal to ⅔ of the circumferential pole pitch and the circumferential space between adjacent active length portions of a given phase is approximately equal to ½ of the active length circumferential width. By this means, the air core armature can be compressed into a thinner structure, as the windings will readily allow for nesting of the phases. In one case, the windings are wound with three phases and compressed into an even number of layers in the active length region. The windings active length width can also be made less than the circumferential pole width in instances when pole width is made less than the pole pitch.

One preferred method for construction of the air core armatures is through the use of a substantially nonmagnetic form wherein the windings are wound onto the form. The form can provide for both location placement and structural support, which is particularly useful when the windings are wound with flexible Litz wire. For axial gap motor-generators one or multiple forms may be stacked together. For radial gap motor-generators it is possible to use only a single form having radial channels for the wires.

The air core armatures may be effectively utilized in both single and double rotating air core motor-generators. In an additional embodiment, the armatures are used in double rotating electrical machines, providing the benefits of higher efficiency and performance and eliminating the need for laminations. In this case, the magnetic airgap is bounded on both sides by rotating surfaces of the rotor.

Although in most cases the air core motor-generator is permanent magnet excited, particularly by attaching a circumferential array of alternating polarity permanent magnets to the rotor for driving the magnetic flux, it is also applicable for use in electrically excited versions of air core motor-generators. These electrical machines employ a field coil to produce the flux in the armature airgap are used in some applications such as flywheel energy storage systems.

### DESCRIPTION OF THE DRAWINGS

FIG. 1 is a schematic sectional elevation of a brushless air core radial gap motor-generator in accordance with the invention.

FIG. 2 is a schematic drawing of a prior art winding pattern for air core armature.

FIG. 3 is a schematic drawing of an alternate prior art winding pattern for air core armature.

FIG. 4 is a graph showing airgap flux distribution for an air core motor-generator in accordance with the invention.

FIG. 5 is a schematic drawing of a winding pattern for air core armature in accordance with the invention.

FIG. 6 is a schematic drawing of an alternate configuration winding pattern for air core armature in accordance with the invention.

FIG. 7 is a schematic drawing of a second alternate configuration winding pattern for air core armature in accordance with the invention.

FIG. 8 is a schematic drawing of a third alternate configuration winding pattern for air core armature in accordance with the invention.

FIG. 9 is a schematic sectional elevation of a brushless air core radial gap motor-generator in accordance with the invention.

FIG. 10 is a schematic sectional elevation of a brushless air core axial gap motor-generator in accordance with the invention.

FIG. 11 is a schematic drawing of an air core armature for an axial gap motor-generator such as the one shown in FIG. 10.

FIG. 12 is a schematic drawing of an air core armature (section view) for motor-generator in accordance with the invention.

### DESCRIPTION OF THE PREFERRED EMBODIMENT

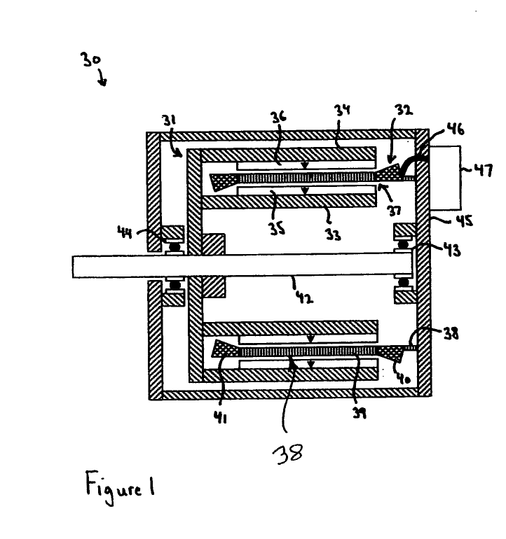

Turning to the drawings, wherein like reference characters designate identical or corresponding parts, FIG. 1 shows a brushless air core radial gap motor-generator 30 constructed of a rotor 31 mounted for rotation relative to a stationary stator 32. The rotor 31 is comprised of two spaced apart steel tubes 33, 34 to which circumferential arrays of alternating polarity magnets 35, 36 are attached. The magnets 35, 36 drive magnetic flux across the armature magnetic airgap 37 formed within the rotor 31. Located in the magnetic airgap 37 is an air core armature 38 that is comprised of windings having active length portions 39 and end turn portions 40, 41. The active length portions 39 are located in the magnet airgap 37 such that AC voltage is induced in the windings as the rotor 31 rotates. The end turn portions 40, 41 traverse circumferentially and connect together the active length portions 39. The rotor 31 is connected to a shaft 42 that is journalled by bearings 43, 44. The outer housing 45 supports the bearings 43, 44 and air core armature 38. The winding leads 46 connect to an electrical junction box 41 for external connection.

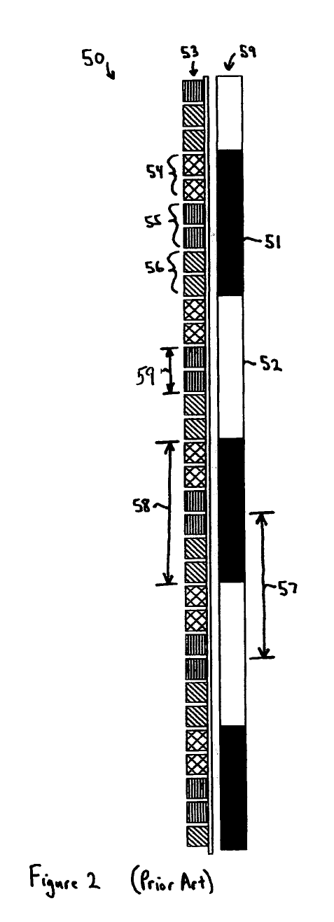

A prior art winding pattern for air core armature is shown in FIG. 2. The armature 50 utilizes a trapezoidal type winding. The rotor 59 has alternating poles 51, 52 and a pole pitch 57. The armature 53 has three phase windings 54, 55, 56 such that the active lengths of all three phases 54, 55, 56 has a combined width 58 that is substantially equal to the pole pitch. Accordingly, the single phase active length width 59 of any particular phase is less than ½ of the pole pitch 57 and approximately equal to ⅓ of the pole pitch for a three phase motor-generator with this type of armature construction. This type of winding, which can be fabricated by winding individual coils, nested stacking them, and pressing the active lengths into a single layer, or by winding together is complicated by the end turn overlapping that is inherent. The end turn portions make winding and fabrication difficult. In addition, only two layers of winding can be used by this method because of the end turn overlapping which must be offset in opposite directions to achieve a compact armature. Performance from this winding construction is limited.

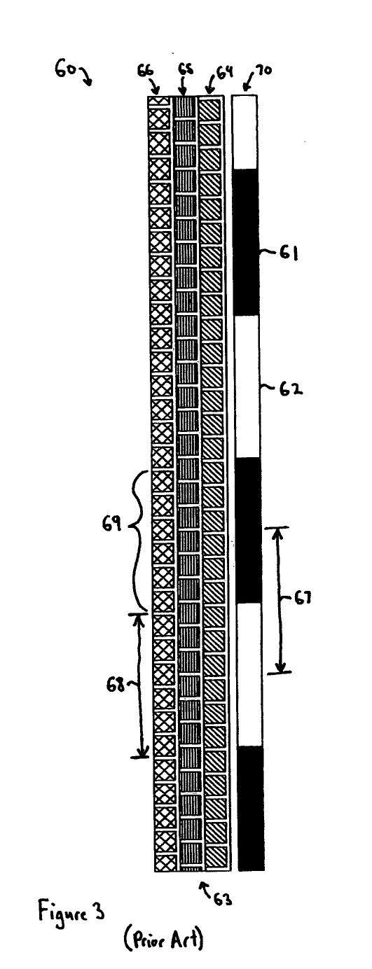

An alternate prior art winding pattern for air core armature is shown in FIG. 3. The armature 60 utilizes a full phase layer type winding. The rotor 70 has alternating poles 61, 62 and a pole pitch 67. The armature 63 comprises three phase windings 64, 65, 66 wherein each phase lies in a different layer. The windings 63 have an active length width 68 made up of same direction traversing winding wires 69. The active length width 68 is substantially equivalent to the pole pitch 67. By this winding method, the armature 63 can be constructed of unlimited thickness and numbers of layers. Since the winding end turns lie in the same planes as the active lengths, end turn overlapping and stacking from the different phases does not occur. Additionally, the armature 63 also achieves maximum windings density for high power and efficiency. As a result, this winding method would seem to be very good. However, it has surprisingly been found to be less than optimal for use in air core motor-generators and especially in ones employing double rotating topology that has an even larger magnetic airgap.

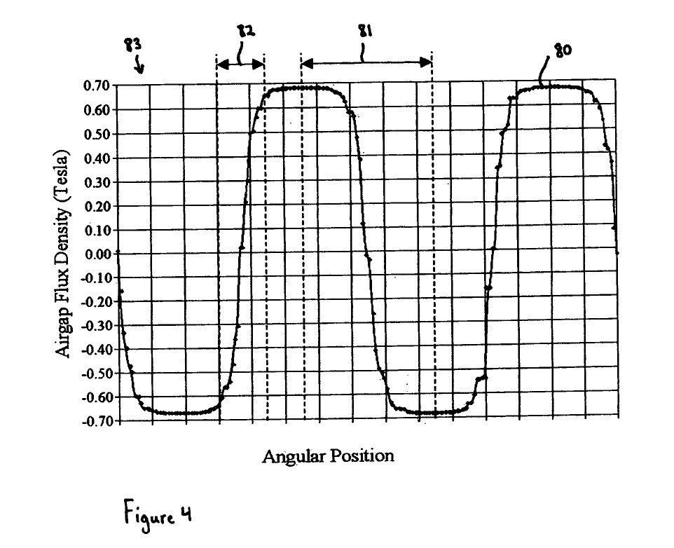

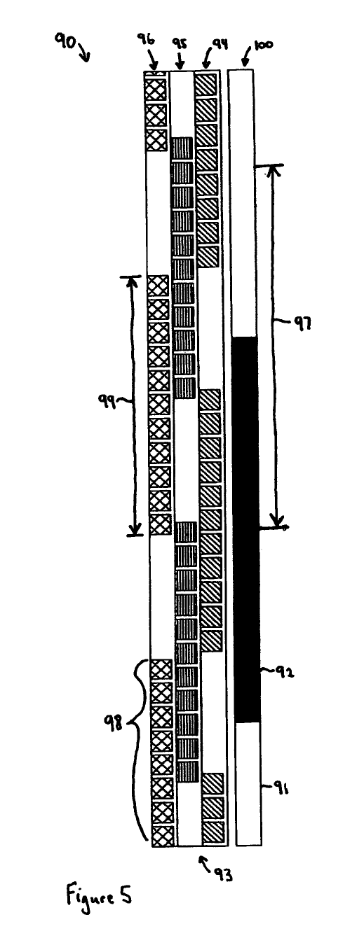

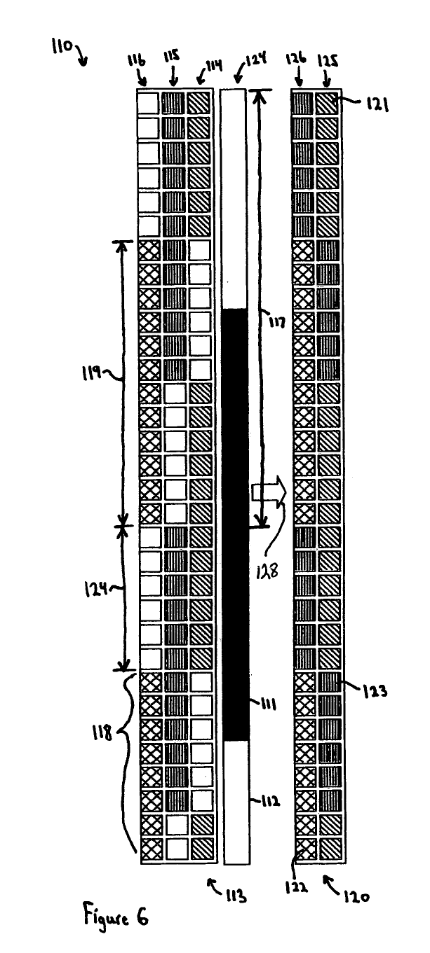

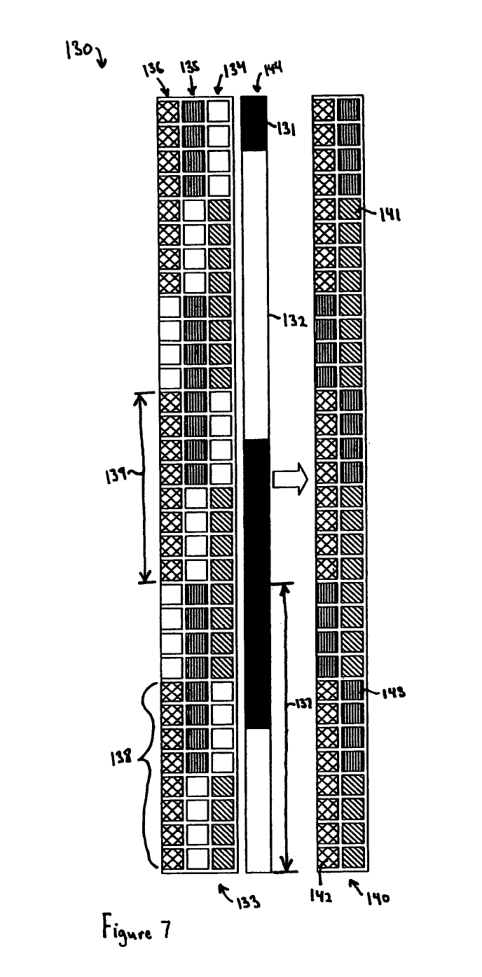

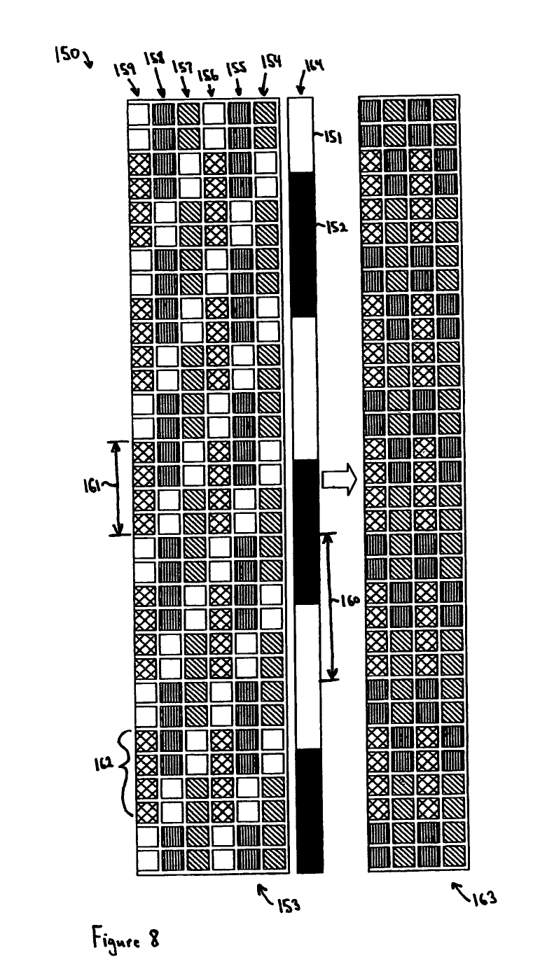

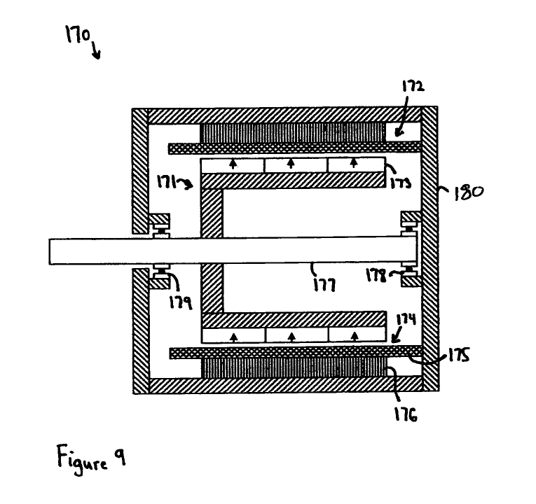

The cause of less than optimal performance for a full phase layer winding construction can be understood by looking at the armature airgap flux density distribution for an air core motor-generator, as illustrated in FIG. 4. Air core motor-generators have a much larger magnetic airgap because the windings are placed directly in the airgap instead of in slots in a steel stator. The magnetic air gap can be ten times larger or more. Because of the very large magnetic airgap, substantial inter-pole magnetic flux leakage occurs whereby magnet end flux jumps between adjacent magnets on one part of the rotor instead of jumping the magnetic airgap to provide torque. The circumferential airgap flux distribution 83 has high flux regions 80 that occur in the central regions of the magnetic poles. The circumferential airgap flux distribution 83 also has a reduced flux region 82 resulting from the leakage and fringing. The reduced flux region 82 is typically less than the pole pitch 81. Because of the significant reduced flux region between the poles, the end conductors of the active length width in the armature are not exposed to significant flux density and hence provide little torque. However, the end conductors do contribute substantially to the armature resistance.

A winding pattern for air core armature in accordance with the invention that provides increased power capability and efficiency is shown in FIG. 5. The winding pattern 90 is hereinafter denoted as an optimal phase layer winding pattern. The rotor 100 comprises alternating magnetic poles 91, 92 with a pole pitch 97. The armature 93 is comprised of three phase windings 94, 95, 96 that are wound in layers. A different number of phases could also be used instead. Each of the phase windings 94, 95, 96 comprises active length conductors 98 in a single direction that have a total active length width 99. To achieve increased performance, the active length width is made less than the pole pitch but also greater than ½ the pole pitch. In this way, the end conductors of a full phase layer winding are omitted, actually reducing the windings density of the air core armature. According to accepted principles, the performance should therefore be reduced. However, the elimination of the end conductors reduces the armature resistance to a much greater extent that it reduces the back emf due to the reduced flux region resulting from the very large magnetic airgap in the air core motor-generator. The efficiency and power capability of the motor-generator have been found to be appreciably increased. An additional benefit of this construction is that it reduces the need for tighter bend radii of the windings in full phase layer construction and has no end turn overlapping winding difficulties as with trapezoidal type windings, making it easier than both as well.

Another winding pattern 110 for an air core armature 113 affording yet further increased efficiency and performance is shown in FIG. 6. The winding pattern 110 hereinafter is denoted as an optimal integer winding pattern. Armature 113 is in an airgap bounded on at least ones side, preferably both sides, by a rotor 124 having magnetic poles 111, 112 and a pole pitch 117. The armature 113 comprises three phase windings 114, 115, 116. Each of the phases 114, 115, 116 has active length conductors 118 that together form a circumferential active length width 119. Again, the active length width is set to be between ½ the pole pitch and the pole pitch to achieve high performance. However, in this winding construction the active length circumferential width is approximately equal to ⅔ of the pole pitch and the circumferential inter-active length width 124 is approximately equal to ½ of the active length width 119. Because of this construction, the windings 110 can be compressed into a thinner armature 120 with higher winding density for a reduced airgap thickness and increased efficiency and performance.

Another air core armature 120, shown juxtaposed to the other side of the rotor 124 for convenience (although both armatures would not be used in the same motor at the same time) has two sides that are perpendicular to the magnetic flux (shown as the hollow arrow 128) and has a first winding layer 125 that is closest to one side and a second winding layer 126 that is closest to the second side. The active lengths of one phase winding 121 lie only in the first winding layer 125, active lengths of a second phase winding 122 lie only in the second winding layer 126 and active lengths of a third phase winding 123 lie in both winding layers 125, 126.

One desirable method for armature construction is to wind the wires onto a substantially nonmagnetic form. The windings preferably utilize Litz type wire to reduce winding eddy current losses. When utilizing the optimal integer winding patter in a form with individual slots the width of the wires and three phase construction, the number of slots around the diameter preferably is equal to the number of conductors per active length width times 3/2 times the number of poles. Additionally, the number of conductors per active length circumferential width is an integer multiple of 4.

Another winding pattern 130 for air core armature 133, shown in FIG. 7, is an optimal integer winding pattern with eight conductors per active length width. The armature 133 is in an airgap of a motor-generator having a rotor 144 with poles 131, 132 and a pole pitch 137. Spaces may also be included between poles to reduce magnet costs in which case the pole width becomes less than the pole pitch. The armature 133 is comprised of multiple phase windings 134, 135, 136 that each comprises active length conductors 138 in a single direction forming the circumferential active length width 139. The active length width is equal to ⅔ of the pole pitch 137 and the windings are compressed into a compacted armature 140, shown on the opposite side of the rotor 144 for convenience of illustration. The armature 140 has the windings 141, 142, 143 that are nested together in the active length region as shown. The end turns, not shown, will be thicker but will not require an increased magnetic airgap thickness by locating them outside of the armature airgap in the motor-generator.

Another configuration winding pattern for windings 150 of air core armature 153, shown in FIG. 8, is a double layered version of an optimal integer winding with four conductors per active length width. Again the windings 150 can be wound as coils or alternatively as a serpentines around the diameter which can be easier and faster. The rotor 164 comprises poles 151, 152 with a pole pitch 160. The armature 153 is wound with phase layers 154, 155, 156, 157, 158, 159 wherein layers 154 and 157, 155 and 158, and 156 and 159 are each of the same phases. Each layer 154, 155, 156, 157, 158, 159 has active length wires 162 of a single direction forming the active length width 161. The windings 150 can then be compressed into a compacted armature 163, shown on the other side of the rotor 164 for convenience of illustration.

The air core armature windings are applicable for use in both double rotating air core motor-generators as previously shown and single rotating versions. A single-sided brushless air core motor-generator 170, shown in FIG. 9, has a rotor 171 and a stator 172. The rotor 171 has a circumferential array of magnetic poles 173 that drive flux across an armature airgap 174. Located in the magnetic airgap 174 is an air core armature 175 that rests against a loss mitigating ferromagnetic stator 176, such as a steel lamination stack. The rotor 171 is connected to a shaft 177 that is journalled in bearings 178, 179. The bearings 178, 179 and armature 175 are supported by the housing 180. This type of air core motor-generator construction can have higher losses due to eddy current and hysteresis losses in the laminations 176. However, the rotor 171 can have lower inertia, which may be beneficial in some applications.

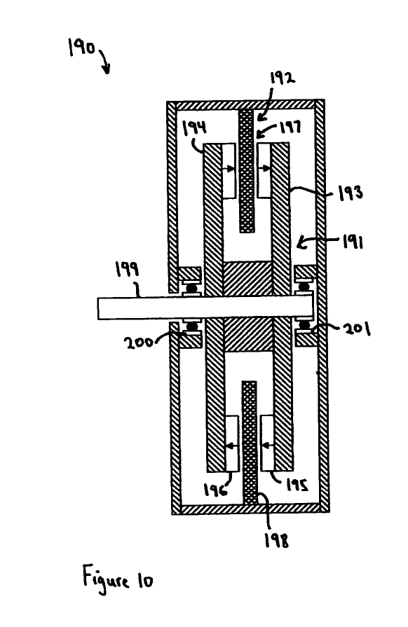

The disclosed air core armature is applicable for use in axial gap air core motor-generators as well as radial gap types shown. A brushless axial gap air core motor-generator 190, shown in FIG. 10, is comprised of a rotor 191 and stator 192. The rotor 191 is constructed with two steel discs 193, 194 that have circumferential arrays of magnetic poles 195, 196 that drive flux across a magnetic airgap 197 created within the rotor 191, and then circumferentially through to discs 193, 193 to the circumferentially adjacent magnet 195, 196 to continue the flux loop. Located within the magnetic airgap 197 is a stationary air core armature 198. The rotor 191 is coupled to a shaft 199 that is supported for rotation by bearings 200, 201.

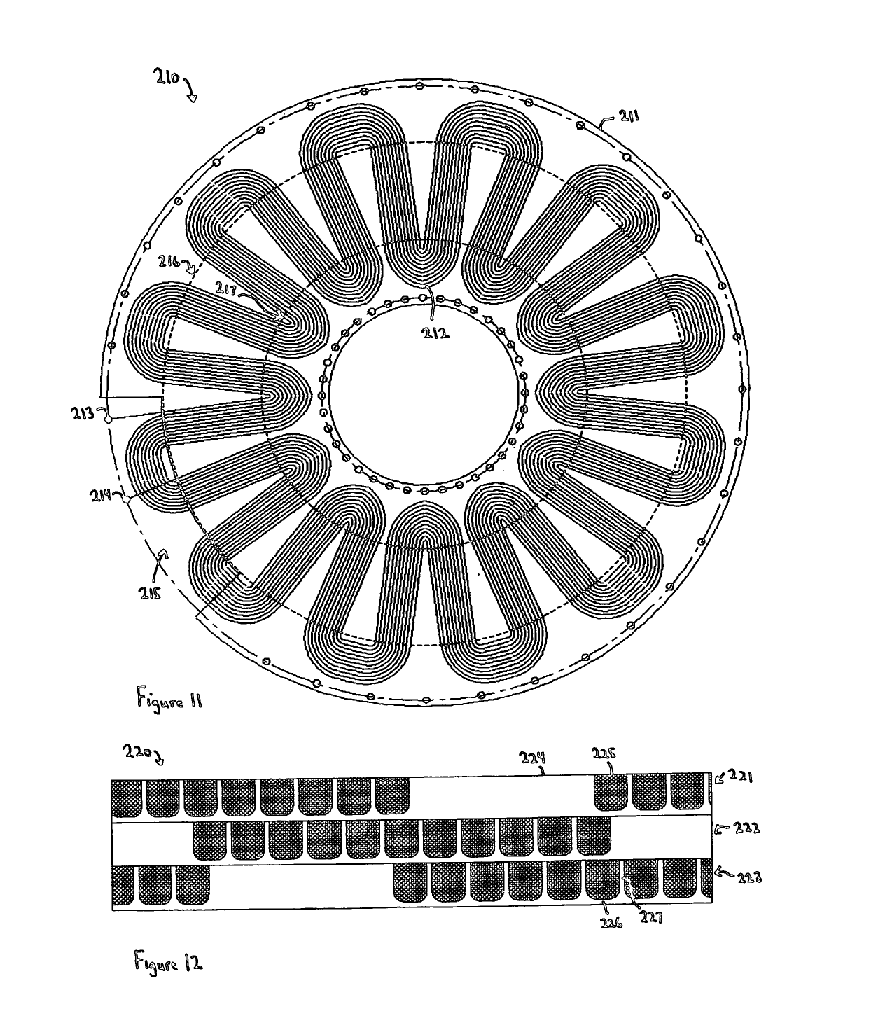

An axial air core armature 210 for an axial gap motor-generator, such as the one shown in FIG. 10, is shown in FIG. 11. Although the windings can be assembled in accordance with the invention by several different means including individual winding and potting, a preferred method uses a nonmagnetic form wherein the windings are wound onto the form. For flexible Litz wire windings the form provides both windings location and structural support during the winding process and in operation. The armature 210 is comprised of a plastic form 211 and windings 212 that are wound into surface channels. The windings 212 have at least one start lead 213 and end lead 214. A cut out section 215 can be provided in the form 211 to account for overlapping of the exit lead 214. The armature 210 preferably is inserted in the motor-generator such that the magnetic poles have an inner pole diameter 217 and an outer pole diameter 216. When using an axial gap motor-generator with the windings in accordance with the invention, the pole pitch and the active length circumferential width are defined by their values at the location of the inner diameter 217 of the magnetic poles. When using an optimal phase layer type winding, the channels for the wires 212 may be complete to support active lengths and end turns (as shown) or they can be incomplete, supporting only a portion of the winding pattern, for example, only the active lengths. When the optimal integer winding pattern is utilized, the channels for the wires 212 can not support the end turns and can only be located in the active length region.

A three-phase air core armature 220 for an axial gap motor-generator in accordance with the invention is shown in FIG. 12. The armature 220 utilizes a triple stack construction for the three phases. The armature 220 is comprised of phases 221, 222, 223 that are axially stacked together. Each phase 221, 222, 223 comprises a plastic form 224 with windings 225 that are wound onto the form 224. The form 224 has a thin backing portion 226 and raised channel walls 227 such that the windings 225 lie between the channel walls 227.

Obviously, numerous modifications and variations of the described preferred embodiment are possible and will occur to those skilled in the art in light of this disclosure of the invention.

Accordingly, I intend that these modifications and variations, and the equivalents thereof, be included within the spirit and scope of the invention as defined in the following claims, wherein I claim:

1. An air core motor-generator for converting between electrical energy and rotational energy comprising:
a rotor that is journalled to rotate about an axis of rotation and a stator that is stationary and magnetically applies torque to said rotor;
said rotor comprising magnetic poles that drive magnetic flux across an armature airgap;
said stator comprising an air core armature located in said armature airgap and comprising windings such that AC voltage is induced in said windings as said rotor rotates;
said windings comprising active length portions that are located in said armature airgap to receive said magnetic flux and induce said AC voltage, and end turn portions that traverse circumferentially and connect together said active length portions;
said magnetic poles having a circumferential pole pitch, Y, and said active length portions of said windings having an active length circumferential width of a single phase, X, such that 0.5 Y<X<Y.

2. An air core motor-generator as described in claim 1 wherein:
0.55 Y<X<0.90 Y.

3. An air core motor-generator as described in claim 2 wherein:
said air core armature comprises a substantially nonmagnetic form with radial channels and said windings are located in said channels.

4. An air core motor-generator as described in claim 1 wherein:
said armature airgap is axial and said pole pitch and said active length circumferential width are defined by their values at the location of the inner diameter of said magnetic poles.

5. An air core motor-generator as described in claim 1 wherein:
said active length circumferential width is approximately equal to ⅔ of said circumferential pole pitch and the circumferential space between adjacent active length portions of a given phase is approximately equal to ½ of said active length circumferential width.

6. An air core motor-generator as described in claim 1 wherein:
said windings are wound with three phases and compressed into an even number of layers in the active length region.

7. An air core motor-generator as described in claim 1 wherein:
said active length circumferential width is also substantially less than the circumferential pole width.

8. An air core motor-generator as described in claim 1 wherein:
said air core armature comprises a substantially nonmagnetic form and said windings are wound onto said form;
said magnetic airgap is bounded on both sides by rotating surfaces of said rotor.

9. An air core motor-generator for converting between electrical energy and rotational energy comprising:
a rotor that is journalled to rotate about an axis of rotation and a stator that is stationary and magnetically applies torque to said rotor;
said rotor comprising magnetic poles that drive magnetic flux across an armature airgap;
said stator comprising an air core armature located in said armature airgap and comprising windings such that AC voltage is induced in said windings as said rotor rotates;
the circumferential width of a section of said air core armature comprising one set of active lengths of each phase is substantially greater than the circumferential pole pitch and the circumferential width of the active length portion of a single phase is less than the circumferential pole pitch.

10. An air core motor-generator as described in claim 9 wherein:
said magnetic airgap is bounded on both sides by rotating surfaces of said rotor.

11. An air core motor-generator as described in claim 9 wherein:
said armature airgap is axial and said pole pitch and said active length circumferential width are defined by their values at the location of the inner diameter of said magnetic poles.

12. An air core motor-generator as described in claim 9 wherein:
said active length circumferential width is approximately equal to ⅔ of said circumferential pole pitch and the circumferential space between adjacent active length portions of a given phase is approximately equal to ½ of said active length circumferential width.

13. An air core motor-generator as described in claim 9 wherein:
said windings are wound with three phases and compressed into an even number of layers in the active length region.

14. An air core motor-generator as described in claim 9 wherein:
said air core armature comprises a substantially nonmagnetic form and said windings are wound onto said form.

15. An air core motor-generator for converting between electrical energy and rotational energy comprising:
a rotor that is journalled to rotate about an axis of rotation and a stator that is stationary and magnetically applies torque to said rotor;
said rotor comprising magnetic poles that drive magnetic flux across an armature airgap;
said stator comprising an air core armature located in said armature airgap and comprising windings such that AC voltage is induced in said windings as said rotor rotates;
said windings comprising active lengths that are located in said armature airgap, receive said magnetic flux and induce said AC voltage and end turn portions that traverse circumferentially and connect together said active lengths;
said air core armature having a two sides that are perpendicular to said magnetic flux and having a first winding layer that is closest to one side and a second winding layer that is closest to the second side;
active lengths of one phase winding lie only in said first winding layer, active lengths of a second phase winding lie only in said second winding layer and active lengths of a third phase winding lie in more than one winding layer.

16. An air core motor-generator as described in claim 15 wherein:
said magnetic airgap is bounded on both sides by rotating surfaces of said rotor.

17. An air core motor-generator as described in claim 15 wherein:
said armature airgap is axial and said pole pitch and said active length circumferential width are defined by their values at the location of the inner diameter of said magnetic poles.

18. An air core motor-generator as described in claim 15 wherein:
said active length circumferential width is approximately equal to ⅔ of said circumferential pole pitch and the circumferential space between adjacent active length portions of a given phase is approximately equal to ½ of said active length circumferential width.

19. An air core motor-generator as described in claim 15 wherein:
said windings are wound with three phases and compressed into an even number of layers in the active length region.

20. An air core motor-generator as described in claim 15 wherein:
said air core armature comprises a substantially nonmagnetic form and said windings are wound onto said form.
